(19) United States
(12) Patent Application Publication
(10) Pub. No.: US 2012/0325834 A1
(43) Pub. Date: Dec. 27, 2012

(54) DISPOSABLE PIZZA-BLOTTING COMPOSITE AND BOX ASSEMBLY INCLUDING SUCH COMPOSITE

(76) Inventors: Bradley Hunter Farrell, Burbank, CA (US); Jennifer Stitz, Cape Girardeau, MO (US)

(21) Appl. No.: 13/169,927

(22) Filed: Jun. 27, 2011

(51) Int. Cl. B65D 90/00; B32B 3/30; B32B 5/02

(52) U.S. Cl. 220/694; 428/221; 428/172

(57) ABSTRACT

A pizza-blotting composite includes an absorbent layer and a non-absorbent layer, the absorbent layer having an oleophilic surface and the non-absorbent layer having an oleophobic surface. The absorbent layer is low-linting and physiologically safe for food contact applications, such as removing oil from pizza. The absorbent layer and the non-absorbent layer are joined to form a composite, which is dimensioned to cover a substantial portion of a pizza's surface. A pizza box assembly is also provided with the pizza-blotting composite, in which the non-absorbent layer of the composite is secured to the interior of the top of the pizza box.

### TECHNICAL FIELD

The present disclosure is directed to a disposable grease-absorbing device and to a pizza box assembly including such a device.

### BACKGROUND

Many people enjoy take-out or delivered pizza as a convenient and economical meal, which has a wide array of options for satisfying individual tastes. Even the frozen pizza market has expanded in recent years, due to the introduction of gourmet toppings at a lower price point. Whether freshly made or frozen, one of the negative aspects of pizzas is their tendency to produce an oily or greasy surface when baked, as the cheese and meat toppings release some of their oil content. As a result, eating a pizza is often a messy exercise.

In the past, some consumers have used napkins to blot excess oil from the pizza's surface before eating to reduce their fat consumption. A problem with this approach is that the oil tends to bleed through the napkin and transfer to the hands of the consumer, thus requiring the use of additional napkins.

Another problem with conventional pizza delivery boxes is that the oily toppings (such as cheese) tend to be absorbed by the box itself. Once oil has been absorbed into the box, the cardboard is no longer recyclable and must be incinerated or landfilled.

What is needed in the industry is an economical pizza-blotting composite for removing excess oil from a pizza. Further, what is needed is a malleable composite that is easily folded after use to prevent oil from being transferred to the hands of the user. Finally, the industry would be well served by a pizza box assembly that includes such a pizza-blotting composite, such that the composite may be removed and discarded, thus enabling the box to be recycled.

### SUMMARY

A pizza-blotting composite includes an absorbent layer and a non-absorbent layer, the absorbent layer having an oleophilic surface and the non-absorbent layer having an oleophobic surface. The absorbent layer is low-linting and physiologically safe for food contact applications, such as removing oil from pizza. The absorbent layer and the non-absorbent layer are joined to form a composite, which is dimensioned to cover a substantial portion of a pizza's surface. A pizza box assembly is also provided with the pizza-blotting composite, in which the non-absorbent layer of the composite is secured to the interior of the top of the pizza box.

### BRIEF DESCRIPTION OF THE DRAWINGS

A full and complete description of the present storage system is provided herein with reference to the appended figures, in which:

FIG. 1 is a perspective view of a pizza-blotting composite, according to a first aspect herein;

FIG. 2 is a cross-sectional view of the pizza-blotting composite of FIG. 1, as taken along line II-II of FIG. 1; and

FIG. 3 is a perspective view of a pizza box assembly containing the pizza-blotting composite of FIG. 1, according to another aspect provided herein.

### DETAILED DESCRIPTION

Reference is now made to the drawings for illustrations of various embodiments of the present pizza-blotting composite and pizza box assembly containing such a pizza-blotting composite. While the discussions herein refer to a round composite, it should be understood that the composite may be made in any shape, as needs dictate, for example, to accommodate rectangular pizzas. Further, although the discussion herein focuses on absorbing oil from pizza surfaces, it should be understood that the composite described herein is equally well suited for absorbing oil from other dishes, such as lasagna.

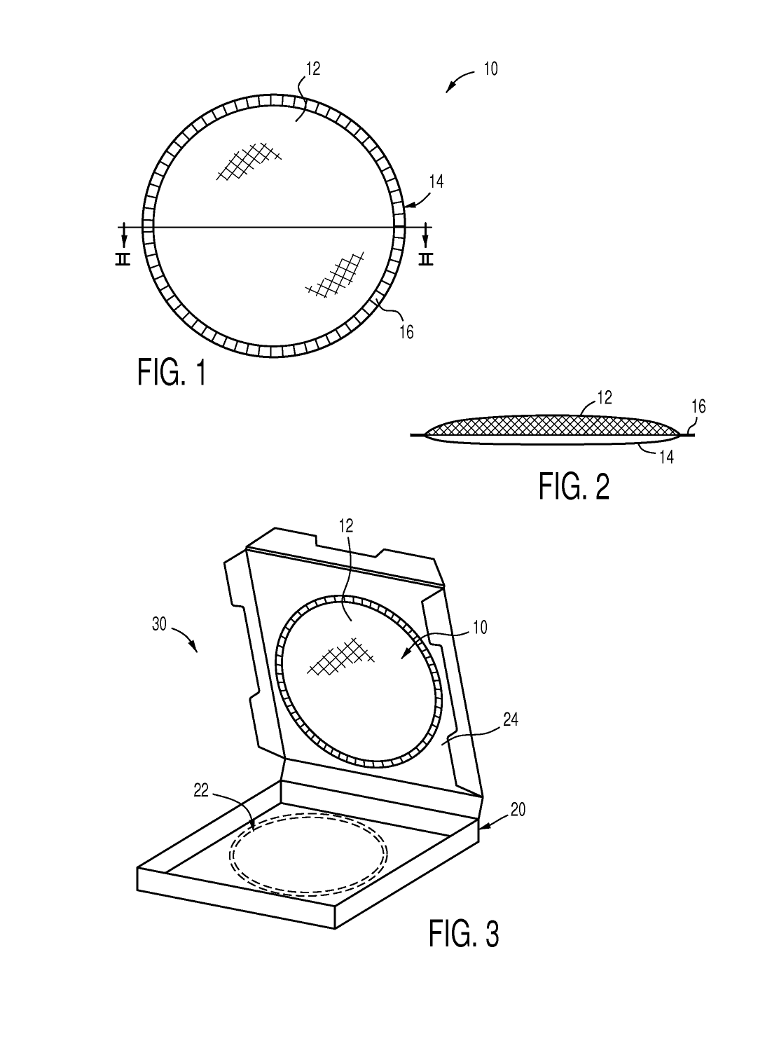

FIG. 1 is a pizza-blotting composite 10 having an absorbent layer 12 that is joined to a non-absorbent layer 14 (seen more clearly in FIG. 2). As illustrated, the composite 10 has a perimeter edge 16, which results from the joining of the absorbent layer 12 to the non-absorbent layer 14. The layers 12, 14 may be joined by any suitable means, including, but not limited to, an adhesive, film lamination, seaming, embossing, quilting, and surface bonding. The composite 10 is dimensioned to cover a substantial portion of a surface of a pizza and, accordingly, may be provided in a number of different sizes to accommodate pizzas of different diameters.

The absorbent layer 12 may be made of any suitable absorbent material that is also oleophilic, or oil-loving, including, but not limited to bi-component micro-fibers, biodegradable fibers, and cellulosic fibers. The absorbent layer 12 is physiologically safe for food contact applications and is low-linting, such that the absorbent layer 12 does not leave lint on the food (e.g., pizza) after contact. By way of example only, the absorbent layer 12 may be a nonwoven web of fibrous material.

The non-absorbent layer 14 (seen in FIG. 2) may be made of any suitable non-absorbent material that is also oleophobic, or oil-hating, including, but not limited to, oleophobic fiber webs and a foil (such as aluminum foil). Advantageously, when the non-absorbent layer 14 is made of foil, the composite 10 is imparted with a desirable degree of malleability, such that the composite may be crumpled after use for convenient disposal without the user having to contact the oil-soaked absorbent layer 12.

In an exemplary embodiment, the absorbent layer 12 may be made of cellulosic fibers and the non-absorbent layer 14 may be made of a foil.

FIG. 3 illustrates a pizza box assembly 30 that includes a pizza box 20 and the pizza-blotting composite 10 shown in FIGS. 1 and 2. The pizza box 20 is a standard collapsible box used commonly in the industry, having an inner receptacle 22 for holding the pizza and a top 24 for covering the inner receptacle 22. The composite 10 is attached to the interior of the top 24 of the box 20, such that the absorbent layer 12 is facing the inner receptacle 22. The composite 10 may be attached to the interior top 24 of the box 20 by any suitable means, including adhesives. In one aspect, the composite 10 is removably attached, for example, using a rubber cement-type of adhesive, so that the composite 10 may be removed after use and the pizza box 20 may be recycled.

The preceding discussion merely illustrates the principles of the present pizza-blotting composites and pizza box assemblies containing such pizza-blotting composites. It will thus be appreciated that those skilled in the art may be able to devise various arrangements, which, although not explicitly described or shown herein, embody the principles of the inventions and are included within their spirit and scope. Furthermore, all examples and conditional language recited herein are principally and expressly intended to be for educational purposes and to aid the reader in understanding the principles of the inventions and the concepts contributed by the inventor to furthering the art and are to be construed as being without limitation to such specifically recited examples and conditions.

Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Terms such as “upper”, “top”, and “lower” are intended only to aid in the reader's understanding of the drawings and are not to be construed as limiting the invention being described to any particular orientation or configuration.

This description of the exemplary embodiments is intended to be read in connection with the figures of the accompanying drawings, which are to be considered part of the entire description of the invention. The foregoing description provides a teaching of the subject matter of the appended claims, including the best mode known at the time of filing, but is in no way intended to preclude foreseeable variations contemplated by those of skill in the art.

What is claimed is:

1. A disposable pizza-blotting composite comprising:
an absorbent layer comprising a low-linting, physiologically safe material having at least one oleophilic surface; and
a non-absorbent layer comprising a malleable material having at least one oleophobic surface,
wherein the absorbent layer and the non-absorbent layer are joined to one another to form a composite and wherein the composite is dimensioned to cover a substantial portion of a top surface of a pizza.

2. The pizza-blotting composite of claim 1, wherein the absorbent layer is comprised of bi-component micro-fibers.

3. The pizza-blotting composite of claim 1, wherein the absorbent layer is comprised of biodegradable fibers.

4. The pizza-blotting composite of claim 1, wherein the absorbent layer is comprised of cellulosic fibers, and wherein the non-absorbent layer is comprised of a foil.

5. The pizza-blotting composite of claim 1, wherein the absorbent layer is joined to the non-absorbent layer by one of an adhesive, film lamination, seaming, embossing, quilting, and surface bonding.

6. The pizza-blotting composite of claim 1, further comprising a pizza box having a top and an inner receptacle covered by the top, the non-absorbent layer being attached to an interior surface of the top of the pizza box.

7. A pizza box assembly comprising:
a collapsible pizza box comprising a top and an inner receptacle covered by the top;
a pizza-blotting composite comprising an absorbent layer comprising a low-linting, physiologically safe material having at least one oleophilic surface; and
a non-absorbent layer comprising a malleable material having at least one oleophobic surface,
wherein the absorbent layer and the non-absorbent layer are joined to one another to form a composite, wherein the composite is dimensioned to cover a substantial portion of a top surface of a pizza, and wherein the non-absorbent layer is attached to an interior surface of the top of the pizza box.

8. The pizza box assembly of claim 7, wherein the pizza-blotting composite is secured to the interior surface of the top of the pizza box by an adhesive.

9. The pizza box assembly of claim 7, wherein the pizza-blotting composite is removable from the pizza box prior to recycling.

10. A disposable pizza-blotting composite comprising:
an absorbent layer comprising a low-linting, physiologically safe material having at least one oleophilic surface; and
a non-absorbent layer comprising a material having at least one oleophobic surface,
wherein the absorbent layer and the non-absorbent layer are joined to one another to form a composite and wherein the composite is dimensioned to cover a substantial portion of a top surface of a pizza.

11. The pizza-blotting composite of claim 10, wherein the absorbent layer is comprised of bi-component micro-fibers.

12. The pizza-blotting composite of claim 10, wherein the absorbent layer is comprised of biodegradable fibers.

13. The pizza-blotting composite of claim 10, wherein the absorbent layer is comprised of cellulosic fibers, and wherein the non-absorbent layer is comprised of a foil.

14. The pizza-blotting composite of claim 10, wherein the absorbent layer is joined to the non-absorbent layer by one of an adhesive, film lamination, seaming, embossing, quilting, and surface bonding.

15. The pizza-blotting composite of claim 10, further comprising a pizza box having a top and an inner receptacle covered by the top, the non-absorbent layer being attached to an interior surface of the top of the pizza box.
